(19) United States
(12) Patent Application Publication
(10) Pub. No.: US 2013/0013387 A1
(43) Pub. Date: Jan. 10, 2013

(54) SYSTEMS AND METHODS FOR AWARDING AND ACCOUNTING FOR POINTS TO A USER TO INCENTIVIZE ACTIVITY

(76) Inventor: Peter A. Groverman, Blue Bell, PA (US)

(21) Appl. No.: 13/347,656

(22) Filed: Jan. 10, 2012

Related U.S. Application Data
(60) Provisional application No. 61/431,335, filed on Jan. 10, 2011.

(51) Int. Cl. G06Q 30/02

(52) U.S. Cl. 705/14.27

(57) ABSTRACT

Computer implemented methods and systems are disclosed for awarding, and accounting for, points to a user, including receiving notification of completion of a pre-defined task by a user, awarding first points to the user, wherein the first points only accumulate in a user account, and awarding second points to the user, wherein the second points can be exchanged for rewards.

### CROSS-REFERENCE TO RELATED APPLICATION

The present application claims the benefit of U.S. Provisional Application No. 61/431,335 filed on Jan. 10, 2011, titled Systems and Methods for Awarding and Accounting for Points to a User to Incentivize Activity, which is hereby incorporated by reference in its entirety.

### TECHNICAL FIELD

The present disclosure relates generally to methods of providing incentives and, more specifically, to systems and methods for awarding and accounting for points to a user to incentivize activity.

### BACKGROUND

There is currently a crisis in education in the United States. Students are falling behind, both with respect to the rest of the world as well as compared to prior generations in this country. Many different ideas have been proposed to attempt to solve this problem, but no current solution seems adequate to meet the country's needs.

Additionally, this generation of students is being raised with technology being a constant companion. Due to the extent of exposure to various technological devices, students are intimately familiar with the intricacies of computers, software, and other technologies. Because their school teachers did not grow up with the same degree of technology, the teachers cannot keep up with their students with respect to technology. The students are technology “natives”, whereas the teachers are technology “immigrants”. There is a need for a system which takes advantage of students knowledge of and desire to use technology, as well as providing teachers with a method of using the technology that they can understand.

### SUMMARY OF THE INVENTION

According to an aspect of the present disclosure, a computer implemented method for awarding, and accounting for, points to a user is disclosed, the method including receiving notification of completion of a pre-defined task by a user, awarding first points to the user, wherein the first points only accumulate in a user account, and awarding second points to the user, wherein the second points can be exchanged for rewards. Additional second points can be purchased by the user. The pre-defined task can be one of the following: attending school, arriving at school on time, arriving at class on time, completing a homework assignment, scoring above x % on an exam, attending an athletic event, competing in an athletic event, having an achievement in an athletic event, attending an extracurricular activity, having an achievement in an extracurricular activity. An amount of first points, Z, and an amount of second points awarded, W, can be based upon pre-determined point values for the pre-defined task. Z and W can be equal. Z and W can be not equal. Z and W can be proportional to each other.

According to another aspect of the present disclosure, a system for awarding, and accounting for, points to a user is provided, the system including: a memory operable to store user account information and a database of pre-defined tasks and associated pre-determined point values; and a processor coupled to the memory and operable to: receive notification of completion of a first pre-defined task by a first user; determine an amount of first points and an amount of second points associated with completion of the first pre-defined task based upon the pre-determined point values; credit an account of the first user with the amount of first points, wherein first points only accumulate in the user account; and credit the account of the first user with the amount of second points, wherein second points can be exchanged for rewards.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings.

FIG. 1 is a flow chart according to an exemplary embodiment of the present disclosure.

FIG. 2 shows an example of a computer system capable of implementing the method and apparatus according to embodiments of the present disclosure.

### DETAILED DESCRIPTION OF THE INVENTION

In the following description, numerous specific details are set forth such as examples of specific components, devices, methods, etc., in order to provide a thorough understanding of embodiments of the present invention. It will be apparent, however, to one skilled in the art that these specific details need not be employed to practice embodiments of the present invention. In other instances, well-known materials or methods have not been described in detail in order to avoid unnecessarily obscuring embodiments of the present invention. While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

Embodiments of the methods described herein may be implemented using computer software. If written in a programming language conforming to a recognized standard, sequences of instructions designed to implement the methods can be compiled for execution on a variety of hardware platforms and for interface to a variety of operating systems. In addition, embodiments of the present invention are not described with reference to any particular programming language. It will be appreciated that a variety of programming languages may be used to implement embodiments of the present invention.

This description of the exemplary embodiments is intended to be read in connection with the accompanying drawings, which are to be considered part of the entire written description.

It has been shown that people respond to a variety of incentives. However, it is not immediately apparent what type of incentive system to create in order to best motivate people. This disclosure will describe different embodiments of methods of providing incentives, as well as software designed for use with the incentivizing method, an algorithm for use with the incentivizing method, and a hardware device for use with the incentivizing process.

The exemplary embodiment of the invention uses two types of “points” in order to provide incentives to complete a given task or sets of tasks. The first type of points is a cumulative score, which cannot be redeemed for rewards. This first type of points will be referred to throughout this disclosure as “gold stars” but this first type of points may have a different name, such as “cumulative points,” “achievement awards,” or some other name.

The second type of points can be used to redeem rewards. This second type of points will be referred to throughout this disclosure as “blue points” but this second type of points may be given a different name, such as “rewards points”, “credits,” or some other name. When blue points are redeemed, they are transferred from the person who received the incentive to the giver of the reward. In certain embodiments, blue points may also be purchased by the person being incentivized. The purchase price for blue points depends on the embodiment. In certain embodiments, anyone eligible to receive blue points can purchase blue points for a set price. In other embodiments, blue points may be purchased for an increasing price as more points are purchased. In other embodiments, blue points may be purchased for a decreasing price as more points are purchased. In other embodiments, blue points may have a different purchase price depending on certain facts about the purchaser or the purchaser's environment, such as the person's socioeconomic status or the institution awarding the blue points.

Depending on the embodiment, the ratio of gold stars to blue points awarded may vary. In some embodiments, gold stars and blue points will be awarded in a one-to-one ratio. In other embodiments, the number of gold stars awarded will be proportional to the number of blue points awarded, where the proportion can be such that the gold stars are greater, or the blue points are greater. In other embodiments, the number of gold stars and blue points awarded will not be proportional and will instead be specified for each given task.

In certain embodiments of the invention, in addition to being rewarded with the two types of points, levels will also be awarded. Depending on the embodiment, the levels can be awarded based on how many gold stars have been earned in general by the person, or else it can be based on needing to achieve a certain number of gold stars in different tasks or different groups of tasks. Depending on the embodiment, being awarded the next level may require either the same number of gold stars, or a different number of gold stars, or a different number of gold stars in different tasks or different groups of tasks.

One way of implementing this method is using a system to keep track of the various components of the method. Some components of the method which may be kept track of by the system include blue points, gold stars, and/or levels, as well as allowing tasks to be created and/or approved for which points are awarded, as well as specifying the amount of each type of point awarded, and if there is a maximum number of times a task can be completed for points, or any bonus points awarded for completing a group of tasks or a given task a certain number of times. The system would have different categories of users; some users would be able to review and approve specified tasks, some users would be able to create specified tasks, and other users would be able to complete specified tasks. Depending on the embodiment of the system, some users may fall in multiple categories, in other embodiments the users would only be in one of the categories.

The following is an algorithm which can be used with the method: If X does Y, X gets Z gold stars and W blue points, where X is a person, and Y is a specified task. As was described above, the relationship between the values Z and W can vary depending upon the embodiment of the invention.

### EDUCATION EMBODIMENT

An exemplary embodiment of the method of incentivizing a process that will be described is a method of incentivizing education. The invention is not meant to be limited only to the process of education and this embodiment is provided for illustrative purposes only.

The example education embodiment uses the two types of “points” described above, gold stars and blue points. Some examples of the type of rewards that blue points can be redeemed for in the context of the example education embodiment include merchandise from a school store, permission to get out of a detention, permission to come to school late, permission to skip homework, and permission to skip a class. Some other examples of the type of rewards that blue points can be redeemed for include goods and/or services outside of the school environment, such as credit on iTunes, movie tickets, credit for bowling, and other activities commonly associated with student discounts.

Depending on the specific embodiment, the educational provider, which may be a public school, a private school, a parochial school, a charter school, an alternative school, a home schooling parent, a non-homeschooling parent, or another entity, may either purchase or be given a certain number of blue points. If the educational provider may purchase blue points, the fee for the points may be a fixed amount or it may vary in the ways described above. There also may be other requirements in order to use the method, such as a set licensing fee, consulting fees, or other fees. The educational provider may then give the points to the students for completing the specified task(s). Then, the students may redeem the blue points either with the educational provider or with an outside entity. Depending on the embodiment, once the points have been redeemed by the educational provider or entity they may be sold back to the owner of this method and/or reused.

In certain embodiments, blue points may also be purchased by the student being incentivized. In the education embodiment, the preferred cost for blue points is an increasing price as more points are purchased, because this tends to prevent rich students from having significantly more points than other students. It is also preferred in the education embodiment for blue points to have a different purchase price depending on certain facts about the student or the student's environment, such as the student's socioeconomic status or the institution awarding the blue points.

For the education embodiment, a variety of ratios of gold stars to blue points awarded can be appropriate. For institutions desiring a more simple to administer system, gold stars and blue points will be awarded in a one-to-one ratio. In other educational embodiments, the number of gold stars awarded will be proportional to the number of blue points awarded, where the proportion can be such that the gold stars are greater, or the blue points are greater. For educational providers requiring the greatest flexibility, the number of gold stars and blue points awarded will not be proportional and will instead be specified for each given task.

In some educational embodiments of the invention, in addition to being rewarded with the two types of points, levels will also be awarded. Depending on the embodiment, the levels can be awarded based on how many gold stars have been earned in general by the person, or else it can be based on needing to achieve a certain number of gold stars in different tasks or different categories of tasks. One list of categories for achieving a level is Academics, Athletics, and Extracurricular Activities. The categories may be drawn more narrowly, or may be broken down into subcategories, such as Mathematics, English, History, Science, and other subjects for Academics, Basketball, Football, Running, Swimming, etc. for Athletics, and Social Service, Student Government, Language Clubs, etc. for Extracurricular Activities. Depending on the embodiment, being awarded the next level may require either the same number of gold stars, or a different number of gold stars, or a different number of gold stars in different tasks or different categories of tasks.

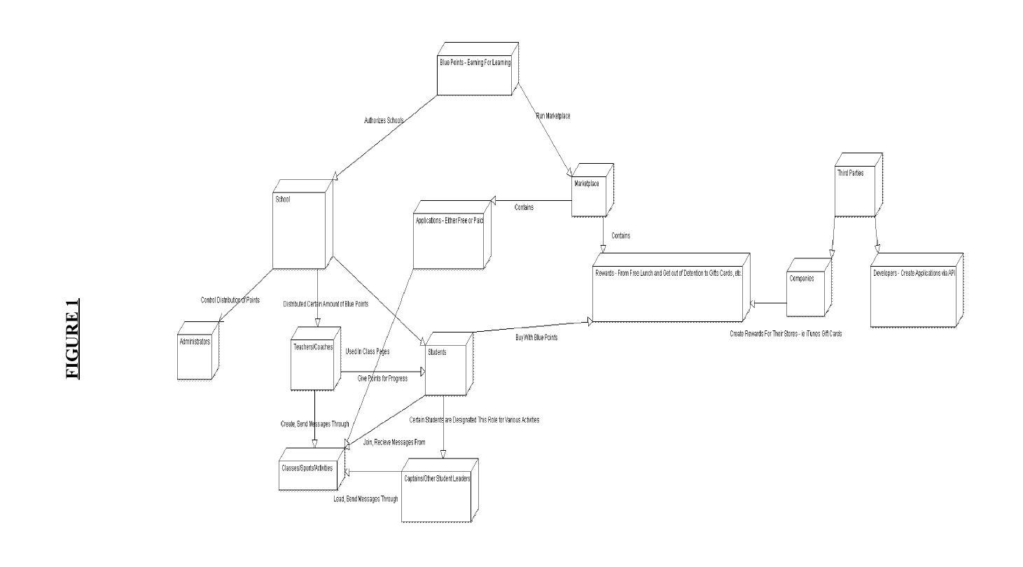

One educational embodiment of the method is illustrated in FIG. 1.

One way of implementing this method for incentivizing education is using a system to keep track of the various components of the method as was described above.

In an exemplary embodiment of the system for use with the method for incentivizing education, administrators and/or department heads would be able to review and approve specified tasks, teachers and potentially some students would be able to create specified tasks, and students would be able to complete specified tasks.

The algorithm described above can be used with the method of incentivizing education As was described above, the relationship between the values Z and W can vary depending upon the embodiment of the invention.

### System Implementations

It is to be understood that embodiments of the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

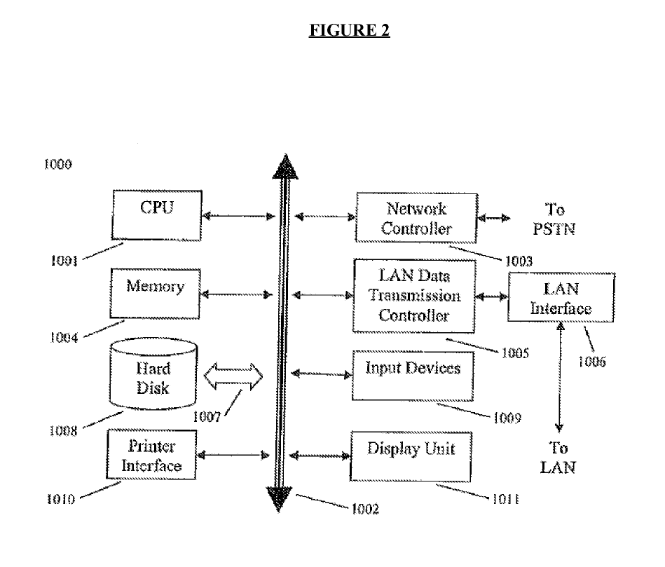

FIG. 2 shows an example of a computer system which may implement a method and system of the present disclosure. The computer system referred to generally as system 1000 may include, inter alia, a central processing unit (CPU) 1001, memory 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

The memory 1004 can include random access memory (RAM), read only memory (ROM), disk drive, tape drive, etc., or a combinations thereof. The present invention can be implemented as a routine that is stored in memory 1004 and executed by the CPU 1001. As such, the computer system 1000 is a general purpose computer system that becomes a specific purpose computer system when executing the routine of the present invention.

The computer system 1000 also includes an operating system and micro instruction code. The various processes and functions described herein can either be part of the micro instruction code or part of the application program or routine (or combination thereof) which is executed via the operating system. In addition, various other peripheral devices can be connected to the computer platform such as an additional data storage device and a printing device.

It is to be further understood that, because some of the constituent system components and method steps depicted in the accompanying figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

While the present invention has been described in detail with reference to exemplary embodiments, those skilled in the art will appreciate that various modifications and substitutions can be made thereto without departing from the spirit and scope of the invention as set forth in the appended claims. For example, elements and/or features of different exemplary embodiments may be combined with each other and/or substituted for each other within the scope of this disclosure and appended claims.

What is claimed is:

1. A computer implemented method for awarding, and accounting for, points to a user comprising:
receiving notification of completion of a pre-defined task by a user;
awarding first points to the user, wherein the first points only accumulate in a user account;
awarding second points to the user, wherein the second points can be exchanged for rewards.

2. The computer implemented method of claim 1, wherein additional second points can be purchased by the user.

3. The computer implemented method of claim 1, wherein the pre-defined task is one of the following: attending school, arriving at school on time, arriving at class on time, completing a homework assignment, scoring above x % on an exam, attending an athletic event, competing in an athletic event, having an achievement in an athletic event, attending an extracurricular activity, having an achievement in an extracurricular activity.

4. The computer implemented method of claim 1, wherein an amount of first points awarded, Z, and an amount of second points awarded, W, are based upon pre-determined point values for the pre-defined task.

5. The computer implemented method of claim 4, wherein Z and W are equal.

6. The computer implemented method of claim 4, wherein Z and W are not equal.

7. The computer implemented method of claim 4, wherein Z and W are proportional to each other.

8. A system for awarding, and accounting for, points to a user comprising:
a memory operable to store user account information and a database of pre-defined tasks and associated pre-determined point values; and
a processor coupled to the memory and operable to:
receive notification of completion of a first pre-defined task by a first user;
determine an amount of first points and an amount of second points associated with completion of the first pre-defined task based upon the pre-determined point values;
credit an account of the first user with the amount of first points, wherein first points only accumulate in the user account;
credit the account of the first user with the amount of second points, wherein second points can be exchanged for rewards.

9. The system of claim 8, wherein additional second points can be purchased by the user.

10. The system of claim 8, wherein the first pre-defined task is one of the following: attending school, arriving at school on time, arriving at class on time, completing a homework assignment, scoring above x % on an exam, attending an athletic event, competing in an athletic event, having an achievement in an athletic event, attending an extracurricular activity, having an achievement in an extracurricular activity.

11. The system of claim 8, further comprising having the capability to allow specified users to create pre-defined tasks.

12. The system of claim 11, further comprising having the capability to allow specified users to collaborate while the specified users create pre-defined tasks.

13. The system of claim 8, further comprising being operable to mediate transactions of the second type of points for rewards.

14. The computer implemented method of claim 1, in which levels are awarded based on the number of the first type of points accumulated.

15. The computer implemented method of claim 14, in which the levels are awarded based on the first type of points having to be accumulated in certain types of tasks.
